(19) United States
(12) Patent Application Publication
(10) Pub. No.: US 2008/0122904 A1
(43) Pub. Date: May 29, 2008

(54) PRINTING APPARATUS HAVING INKJET CARTRIDGE

(75) Inventors: Cheng Lin Tsai, Zhongli City (TW); Chih Hung Chen, Jiali Town (TW)

Correspondence Address: SNELL & WILMER L.L.P. (Main), 400 EAST VAN BUREN, ONE ARIZONA CENTER, PHOENIX, AZ, 85004-2202, US

(73) Assignees: BENQ CORPORATION, Taipei (TW); QISDA CORPORATION, Gueishan Hsiang (TW)

(21) Appl. No.: 11/945,527

(22) Filed: Nov. 27, 2007

(30) Foreign Application Priority Data
Nov. 28, 2006 (TW) 095113496

(51) Int. Cl. B41J 2/175

(52) U.S. Cl. 347/86

(57) ABSTRACT

A printing apparatus including a separable ink cartridge, a body, and an isolating mechanism is provided. The ink cartridge is formed with a first electronic pad. The body is formed with a circuit board having a second electronic pad. During the installation of the ink cartridge, the isolating mechanism allows the first electronic pad and the second electronic pad to isolate from each other for preventing abrasion. When the ink cartridge reaches to a predetermined position, the function of the isolating mechanism will cease to allow the first electronic pad to contact the second electronic pad.

### CROSS REFERENCE TO RELATED APPLICATIONS

This application claims the right of priority based on Taiwan Patent Application No. 095143946 entitled “PRINTING APPARATUS HAVING INJECT CARTRIDGE,” filed on Nov. 28, 2006, which is incorporated herein by reference and assigned to the assignee herein.

### FIELD OF INVENTION

The invention is generally related to a printing apparatus, especially to a printing apparatus having an ink cartridge.

### BACKGROUND OF THE INVENTION

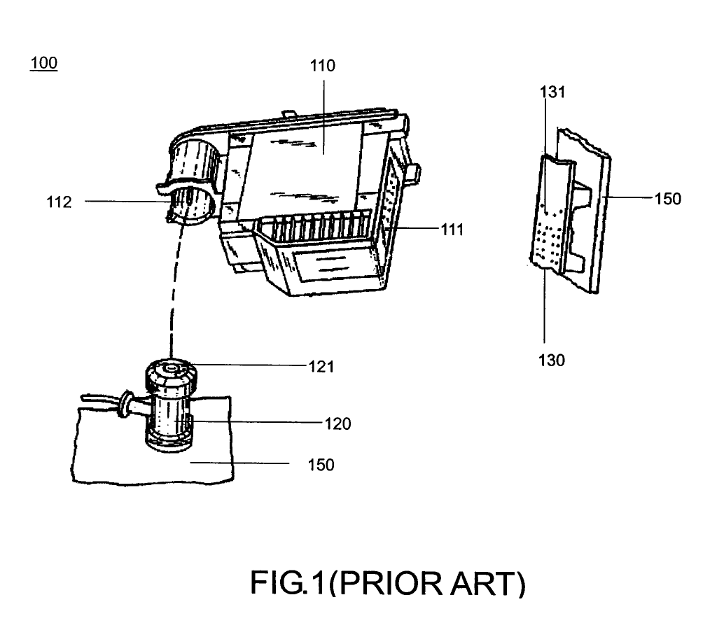

FIGS. 1, 2A-2C, and 3A-3B illustrate a conventional inkjet printer 100. As shown in FIG. 1, the inkjet printer 100 includes an ink cartridge 110, an ink supplier 120, a driving element 130, and the ink supplier 120 and the driving element 130 are fixed on a body 150. The ink cartridge 110 includes a first electronic pad 111 contacting with a second electronic pad 131 on the driving element 130, which allows the ink cartridge 110 to receive electronic signals from the driving element 130 and then drives the ink cartridge 100 to eject ink. Therefore, whether the first electronic pad 111 and the second electronic pad 131 have a good contact is critical to the operation of the inkjet printer 100.

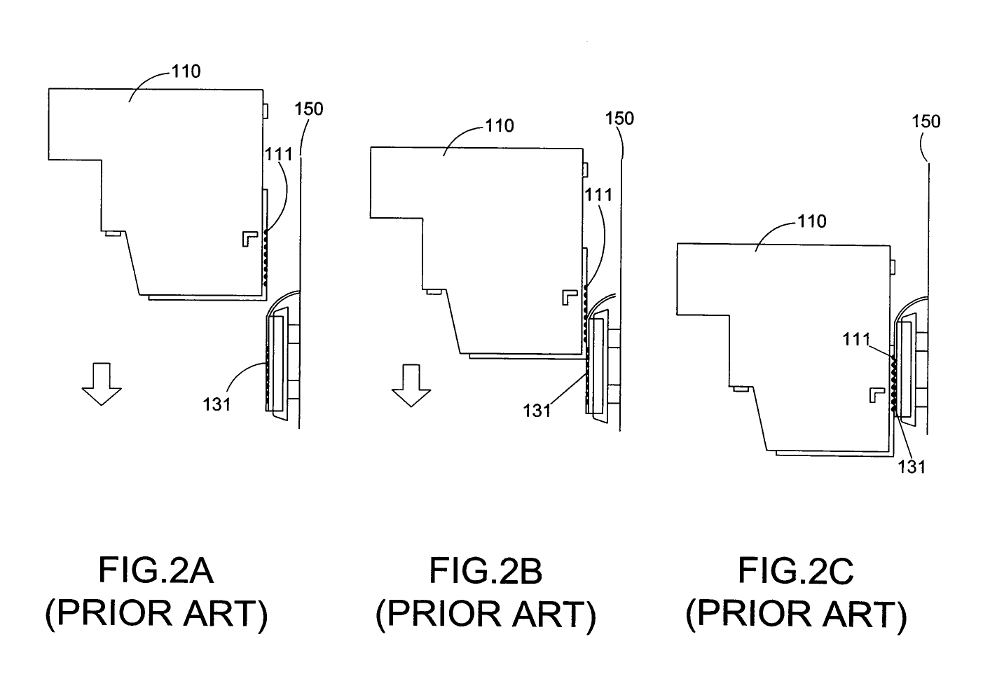

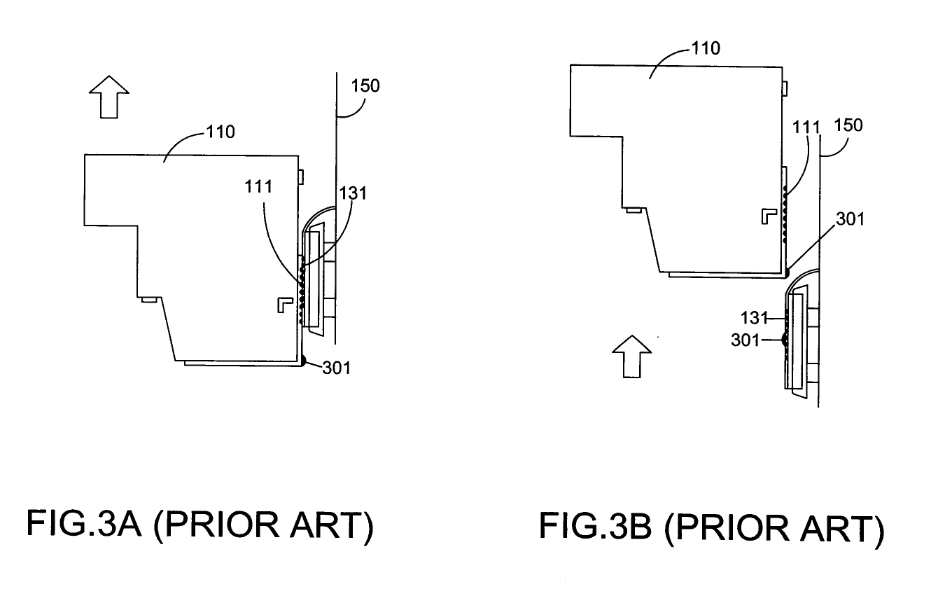

The conventional ink cartridge 110 includes a needle 112 configured to insert into a hole 121 of the ink supplier 120. Therefore, in order to allow the needle 112 to be easily inserted into the hole 121, the ink cartridge 110 must be vertically installed on the body 150 along the path as shown by the dotted line of FIG. 1. FIGS. 2A-2C illustrate the cross section views of the conventional ink cartridge 110 during installation. As shown in FIGS. 2B-2C, the first electronic pad 111 and the second electronic pad 131 rub with each other. After multiple times of installation, abrasion occurs on the first electronic pad 111 and the second electronic pad 131, which further results in the undesired contact failure. In addition, during injection operation, as is known to a person skilled in the art, an ink residue 301 may remain on a location near the ejecting head beneath the first electronic pad 111. Thus, when the ink cartridge 110 is disengaged from the body 150 as shown in FIGS. 3A-3B, the second electronic pad 131 will be contaminated by the ink residue 301.

Therefore, it is necessary to provide an inkjet printing apparatus for solving or alleviating the problems in the prior art as described above.

### SUMMARY OF THE INVENTION

The present invention provides a printing apparatus having a separable ink cartridge, which includes an isolating mechanism. When the ink cartridge is installed into or disengaged from the body of the printing apparatus, the isolating mechanism can allow the electronic pads on the ink cartridge to isolate from the body and prevent abrasion of the electronic pads. In addition, during the installation or the disengagement, the isolating mechanism of the present invention can allow a plane where the electronic pads of the ink cartridge are located to keep a proper distance from the body and therefore prevent an ink residue remaining on the plane or on the body from touching the electronic pads.

A printing apparatus using a blocking element as the isolating mechanism is provided. In one embodiment, the present invention provides a printing apparatus, which includes an ink cartridge having a first electronic pad; a body having a circuit element, the circuit element having a second electronic pad; and a blocking element selectively disposed on the body or the ink cartridge. When the ink cartridge approaches the body for installation, the blocking element isolates the first electronic pad from the second electronic pad. When the blocking element or the ink cartridge engages with the body, the first electronic pad contacts with the second electronic pad.

In the above-described printing apparatus, the blocking element is selectively disposed on the first plane or the second plane. When there is an ink residue on the first plane or the second plane, the blocking element can allow the first plane to keep a proper distance from the second plane and therefore prevent the first electronic pad or the second electronic pad from touching the ink residue.

A printing apparatus using a magnetic element as the isolating mechanism is provided. In another embodiment, the present invention provides a printing apparatus, which includes an ink cartridge having a first electronic pad; a first magnetic element disposed on the ink cartridge; a body having a circuit element, the circuit element having a second electronic pad; and a second magnetic element disposed on the body. When the ink cartridge approaches the body for installation, a repulsive force generated from the first magnetic element and the second magnetic element isolates the first electronic pad from the second electronic pad. When the repulsive force disappears, the first electronic pad contacts with the second electronic pad.

In the above-described printing apparatus, when there is an ink residue on the first plane or the second plane, the repulsive force can allow the first plane to keep a proper distance from the second plane and therefore prevent the first electronic pad or the second electronic pad from touching the ink residue.

### BRIEF DESCRIPTION OF THE PICTURES

The present invention is illustrated by way of example and not intended to be limited by the figures of the accompanying drawing, in which like notations indicate similar elements.

FIG. 1 is an explosive view showing part of a conventional inkjet printer;

FIGS. 2A-2C are schematic cross-section views illustrating the process of installing an ink cartridge shown in FIG. 1;

FIGS. 3A-3B are schematic cross-section views illustrating the process of disengaging the ink cartridge shown in FIG. 1;

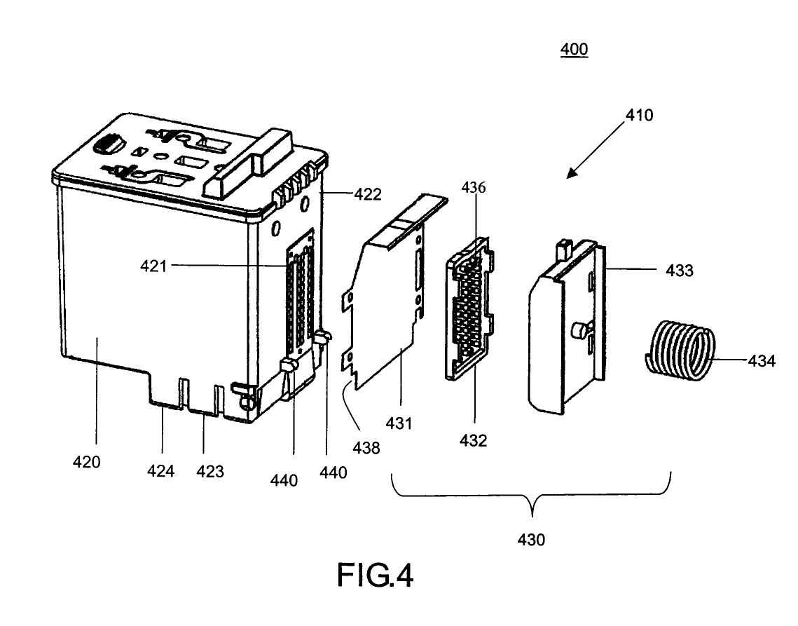

FIG. 4 illustrates an explosive view showing part of a printing apparatus in accordance with a first embodiment of the present invention;

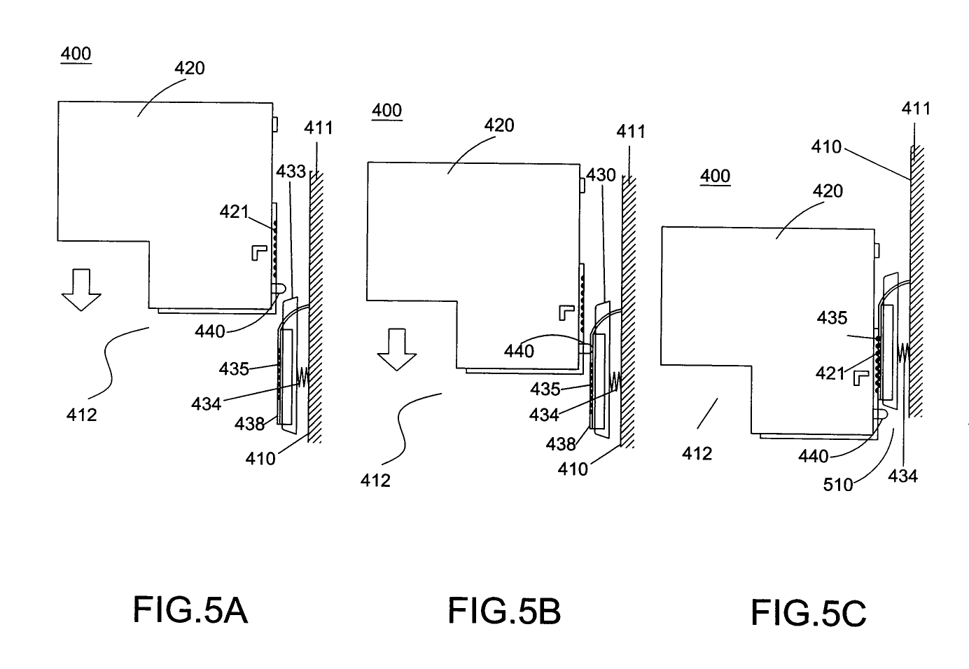

FIGS. 5A-5C are schematic cross-section views illustrating the process of installing an ink cartridge shown in FIG. 4;

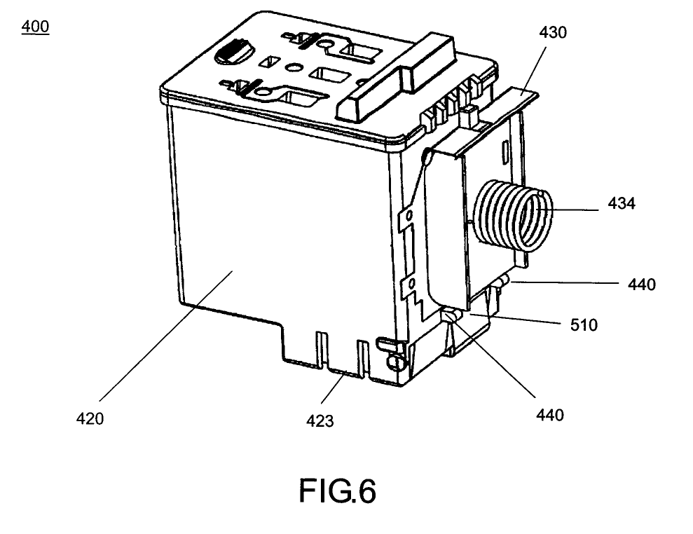

FIG. 6 is a perspective view of the printing apparatus with the ink cartridge engaging with a body in accordance with the first embodiment of the present invention;

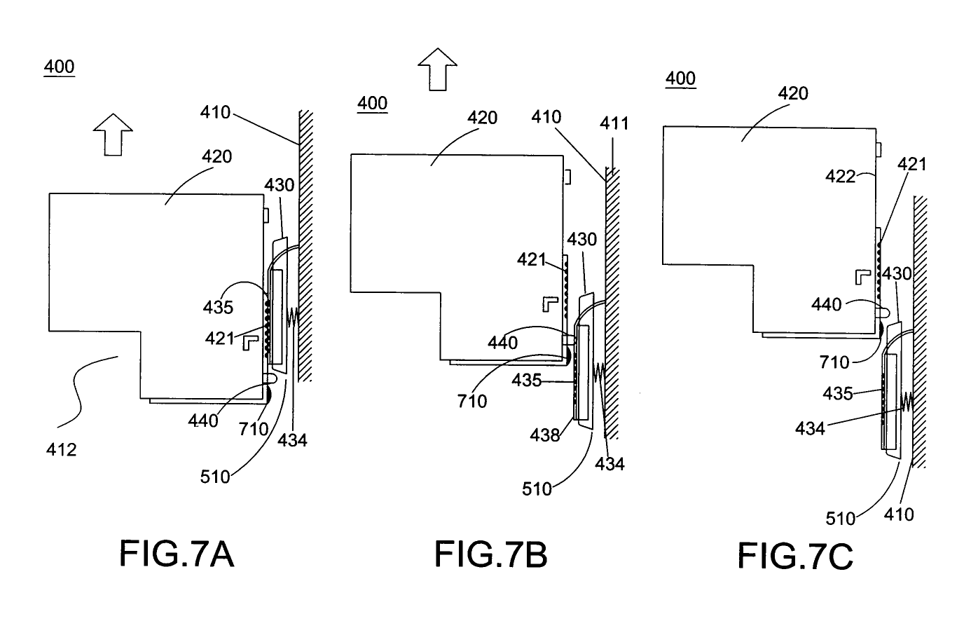

FIGS. 7A-7C are schematic cross-section views illustrating the process of disengaging the ink cartridge shown in FIG. 4;

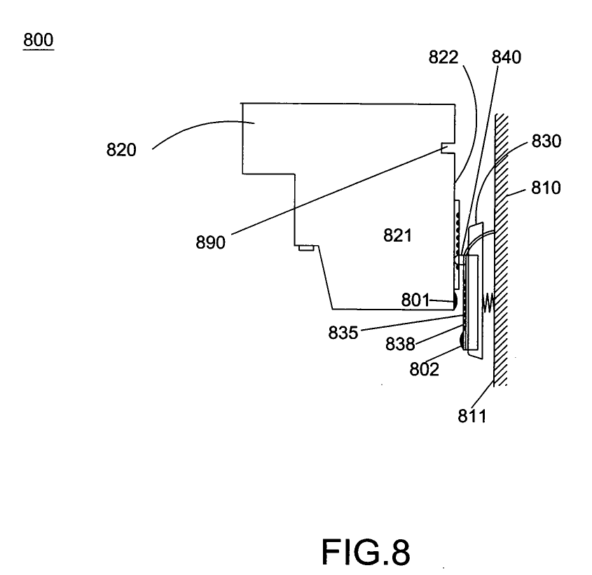

FIG. 8 is a schematic cross-section view of a printing apparatus in accordance with a second embodiment of the present invention;

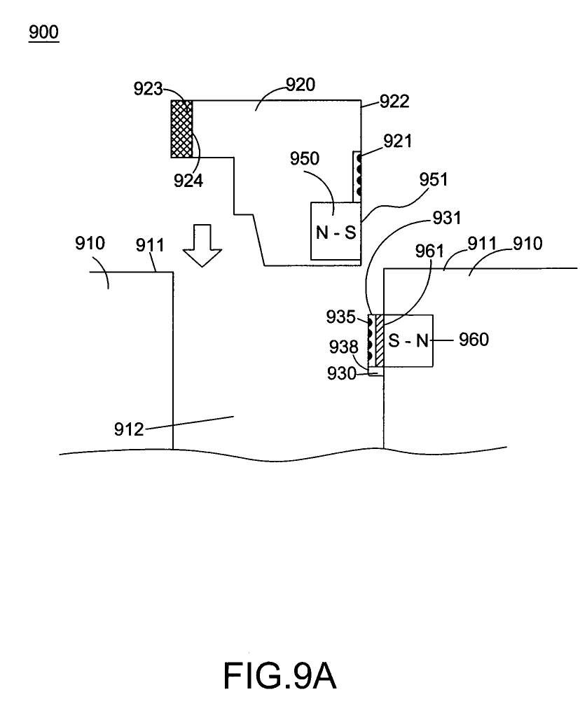

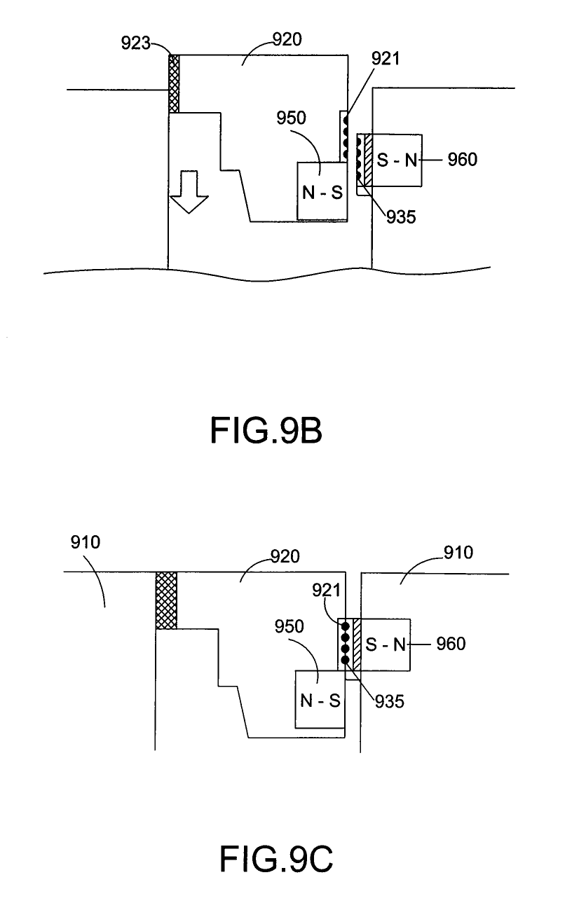

FIGS. 9A-9C are schematic cross-section views illustrating the process of installing an ink cartridge of a printing apparatus in accordance with a third embodiment of the present invention;

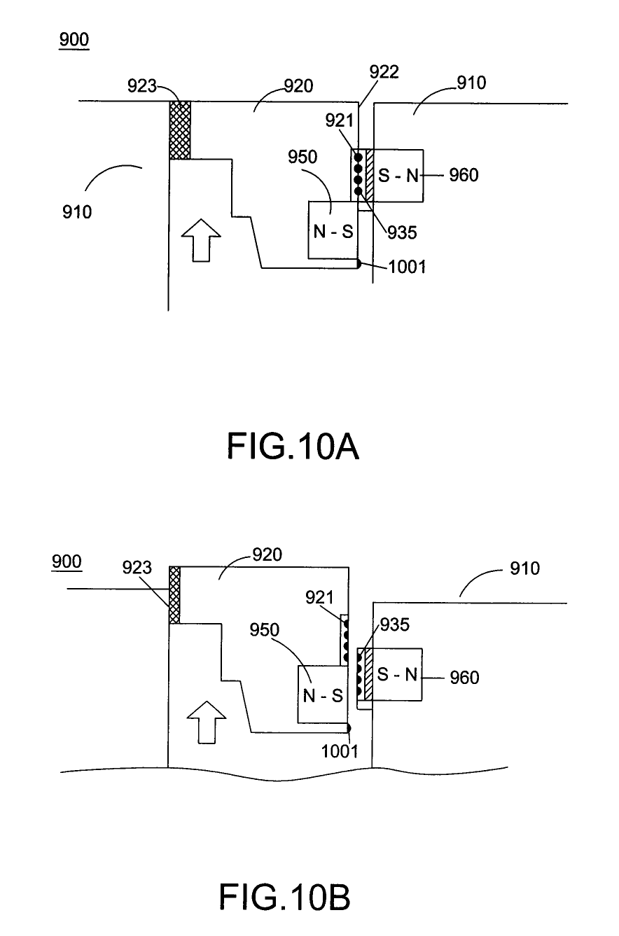

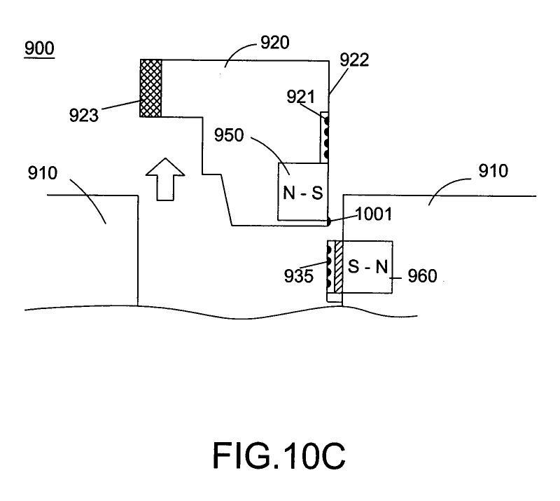

FIGS. 10A-10C are schematic cross-section views illustrating the process of disengaging the ink cartridge of the printing apparatus in accordance with the third embodiment of the present invention; and

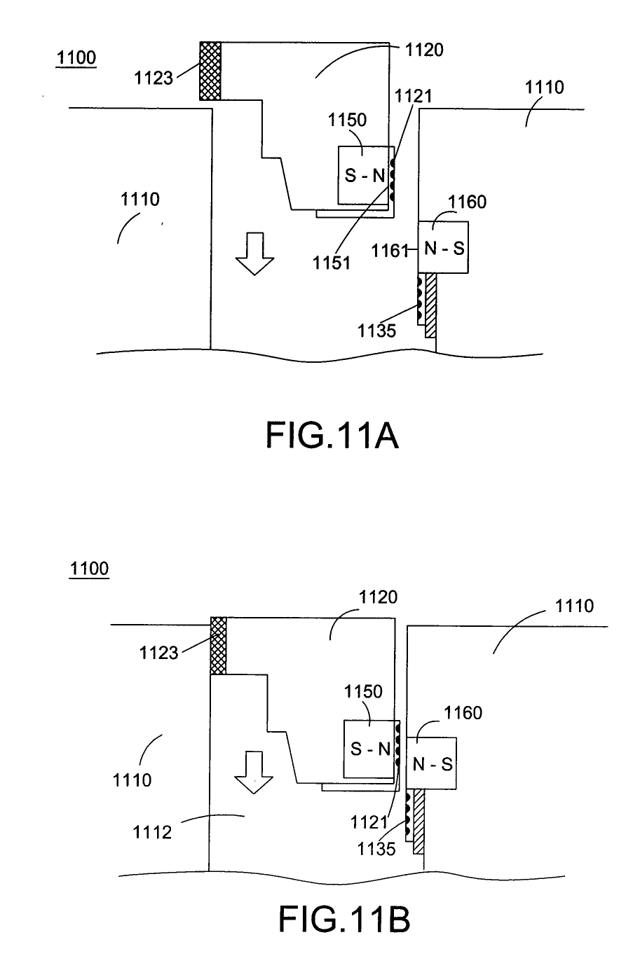

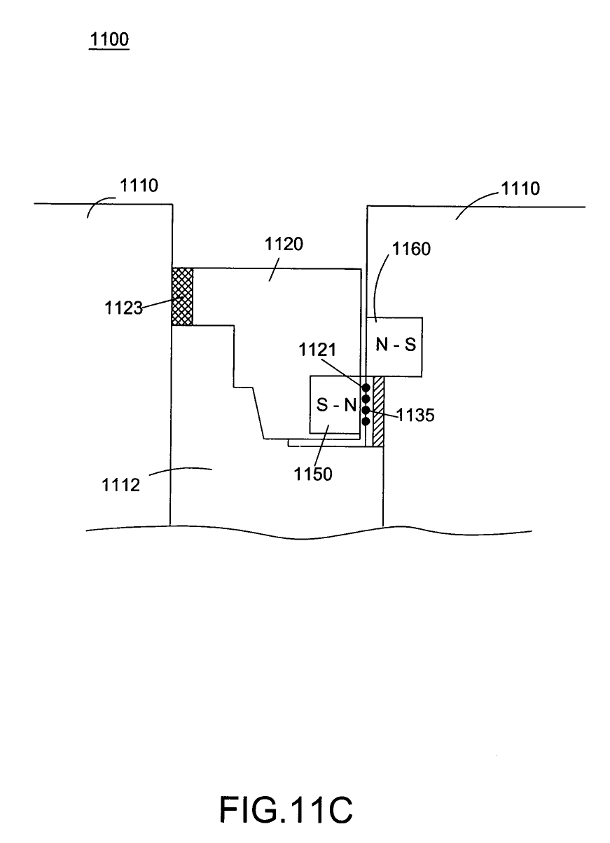

FIGS. 11A-11C are schematic cross-section views illustrating the process of installing an ink cartridge of a printing apparatus in accordance with a fourth embodiment of the present invention.

### DETAILED DESCRIPTION OF THE INVENTION

The preferred embodiments of the present invention will now be described in greater details by referring to the drawings that accompany the present application. In these drawings, like notations indicate similar elements. It should be noted that the features illustrated in the drawings are not necessarily drawn to scale. Descriptions of well-known components, materials, and process techniques are omitted so as not to unnecessarily obscure the embodiments of the invention.

FIG. 4 illustrates an explosive view showing part of a printing apparatus 400 in accordance with a first embodiment of the present invention. As shown in FIG. 4, the printing apparatus 400 includes a body 410 (only illustrating some components), an ink cartridge 420 separably connected to the body 410, and a blocking element 440. The ink cartridge 420 includes a plurality of first electronic pads 421 disposed on a first plane 422; a nozzle 423 disposed on another plane 424 adjacent to the first plane 422. As shown in FIG. 4, the blocking element 440 is disposed on the first plane 422, and the present invention includes at least one blocking element 440, preferably including two or more blocking elements 440. The body 410 includes a circuit element 430 configured to electrically connect to the ink cartridge 420. The circuit element 430 includes a circuit board 431, a first resilient element 432, a circuit board supporter 433, and a second resilient element 434. The circuit board 431 includes a second plane 438 with a plurality of second electronic pads 435 (not shown) disposed thereon. When the ink cartridge 420 is installed on the body 410, the second plane 438 faces the first plane 422, and the plurality of second electronic pads 435 contact the corresponding first electronic pads 421, so that the ink cartridge 420 is capable of receiving electronic signals from the circuit board 431 and further driving the nozzle 423 to eject ink. The first resilient element 432 includes a plurality of protrusions 436 corresponding to the second electronic pads 435 respectively, which can facilitate the first electronic pads 421 to tightly contact the second electronic pads 435. With respect to the number of the first electronic pads 421, note that the plurality of the first electronic pads 421 shown in the embodiment is for illustration—not limitation. The present invention also includes an embodiment with only one first electronic pad 421. This likewise applies to the second electronic pads 435 and the protrusion 436. The circuit board supporter 433 is configured to support the circuit board 431 and the first resilient element 432. The second resilient element 434 has the function of making the circuit element 430 tightly contact the ink cartridge 420, and will be described in the following description.

FIGS. 5A-5C are cross-section views which illustrate the process of installing the ink cartridge 420 on the body 410 in accordance with the first embodiment of the present invention. As shown in drawings, the circuit element 433 is connected to a housing 411 of the body 410 through the second resilient element 434, and the body 410 includes a space 412 for receiving the ink cartridge 410.

The arrow shown in FIG. 5A represents the installation direction of the ink cartridge 420, that is, the ink cartridge 420 moves into the space 412 in a direction parallel with the second plane 438. Note that the blocking element 440 is preferably disposed beneath the first electronic pads 421 (also shown in FIG. 4). Thus, during the illustration, the blocking element 440 moves into the space 412 before the first electronic pads 421 does.

Next, referring to FIG. 5B, the ink cartridge 420 continues to be pushed into the space 412, and hence the second resilient element 434 is compressed. At this time, the blocking element 440 is pressed against the second plane 438 and slides downwards. Since the blocking element 440 is protruded between the first plane 422 and the second plane 438, it can isolate the first electronic pads 421 from the second electronic pads 435. Note that, in this embodiment, because the blocking element 440 can slide on the second plane 438, any electronic pads should be positioned away from the sliding path on the second plane 438.

Now refer to FIG. 5C, showing a configuration, in which the installation is completed. Specifically, the ink cartridge 420 continues to be pushed, so that the blocking element 440 slides into a gap 510 under the second electronic pads 435. Therefore, the ink cartridge 420 engages with the body 410 and further makes the first electronic pads 421 contact the second electronic pads 435. At the moment, note that the compressed second resilient element 434 is released and simultaneously generates an elastic force to push the circuit board 431 and then facilitate the circuit element 430 to be much more tightly in contact with the ink cartridge 420.

FIG. 6 is a perspective view of the printing apparatus 400, in which the ink cartridge 420 engages with the circuit element 430 (which is part of the body 410). For reasons of clarity, other part of the body 410 is not shown in FIG. 6. As shown in FIG. 6, when the ink cartridge 420 engages with the circuit element 430, the blocking element 440 is located in the gap 510 under the circuit element 430.

FIGS. 7A-7C are schematic cross-section views of the printing apparatus 400 of the first embodiment, which illustrate the process of disengaging the ink cartridge 420 from the body 410. Please note that there is an ink residue 710 located on the first plane 422 under the blocking element 440. The arrow shown in FIG. 7A represents the disengagement direction of the ink cartridge 420, that is, the ink cartridge 420 moves out of the space 412 in a direction parallel with the second plane 438. The configuration shown in FIG. 7B can be formed by compressing the second resilient element 434 first and then pushing the ink cartridge 420 upwards. Therefore, as described above, the blocking element 440 can be moved out of the gap 510 and then protruded between the first plane 422 and the second plane 438, which can isolate the first electronic pads 421 from the second electronic pads 435 and also can prevent the second electronic pads 435 from contacting with the ink residue 710. The blocking element 440 can be pressed against the second plane 438 and slide away from the body 410, as shown in FIG. 7C.

A second embodiment of the present invention is shown schematically by a cross-section view in FIG. 8. The difference between the second embodiment and the first embodiment is the position of the blocking element. In a printing apparatus 800 of the second embodiment, a blocking element 840 is disposed on a second plane 838 of a circuit board 831. Specifically, as shown in FIG. 8, the blocking element 840 is preferably located above second electronic pads 835, so that the ink cartridge 820 can press against the blocking element 840 and slide relatively during the installation of the ink cartridge 820. Since the blocking element 840 is now protruded between the first plane 822 and the second plane 838, it can isolate first electronic pads 821 from the second electronic pads 835. As aforementioned, it should be noted that any electronic pads should be away from the sliding path of the blocking element 840 on the first plane 822. Next, please note that the ink cartridge 820 shown in FIG. 8 further includes a gap 890 for receiving the blocking element 840. The ink cartridge 820 can be pushed to make the blocking element 840 slide into the gap 890, thereby cease the blocking function of the blocking element 840 and allow the first electronic pads 821 to contact the second electronic pads 835.

Since the disengagement process of the ink cartridge 820 of the printing apparatus 800 is similar with that of the first embodiment of the present invention, the description thereof is omitted. However, please note that, as shown in FIG. 8, the ink residues 801 and 802 remain on the first plane 822 and the second plane 838 respectively. The blocking element 840 can isolate the first electronic pads 821 from the ink residue 802 and also can isolate the second electronic pads 835 from the ink residue 801 during the disengaging process of the ink cartridge 820, as described above. Please note that for illustration purpose, the blocking element 840 of the second embodiment is disposed on the circuit element 830 while being disposed on any other suitable position of the body 801 is also included in the present invention.

FIGS. 9A-9C are schematic cross-section views illustrating a third embodiment of the present invention. The third embodiment differs from the previous embodiments in that a magnetic element, instead of the blocking element, is used to perform the isolating mechanism.

As shown in FIG. 9A, a printing apparatus 900 includes a body 910 and an ink cartridge 920 separably connected to the body 910. The body 910 includes a circuit element 930 and a space 912 for receiving the ink cartridge 920, and the circuit element 930 further includes a circuit board 931 and a first resilient element 932 (not shown) connected to the circuit board 931, wherein the function of the first resilient element 932 has been described above. In this embodiment, the space 921 is defined by a housing 911 of the body 910. The ink cartridge 920 includes a plurality of first electronic pads 921 disposed on a first plane 922 and a plurality of second resilient element 923 disposed on another plane 924 facing the first plane 922. The function of the second resilient element 923 will be described in the following. The circuit board 931 includes a plurality of second electronic pads 935 disposed on a second plane 938. When the ink cartridge 920 is engaged with the body 910, the second plane 938 is opposite to the first plane 922 and the plurality of second electronic pads 935 are in contact with the corresponding first electronic pads 921 respectively, thereby the ink cartridge 920 can receive electronic signals from the circuit board 931 and then eject ink.

In addition, as shown in FIG. 9A, the printing apparatus 900 further includes a first magnetic element 950 disposed in the ink cartridge 920 and a second magnetic element 960 disposed in the body 910. Specifically, the arrow shown in FIG. 9A represents the installation direction of the ink cartridge 920, that is, the ink cartridge 920 moves into the space 912 in a direction parallel with the second plane 938. The first magnetic element 950 has a first surface 951 configured to be opposite to a second surface 961 of the second magnetic element 960. In this embodiment, the circuit element 930 (or the plurality of second electronic pads 935) covers the second surface 961, but the plurality of first electronic pads 921 don't cover the first surface 951. During the installation of the ink cartridge 920, the first magnetic element 950 moves into the space 912 before the first electronic pads 921 moves into the space 912. Next, referring to FIG. 9B, when the ink cartridge 920 continues to be pushed and then moves into the space 912, a repulsive force is generated as the first magnetic element 950 approaches the second magnetic element 960. The repulsive force can isolate the first electronic pads 921 from the second electronic pads 935 and compress the second resilient element 923 simultaneously.

Now refer to FIG. 9C, which shows a configuration in which the installation is completed. Specifically, the ink cartridge 920 continues to be pushed, so that the first magnetic element 950 does not confront the second magnetic element 960 and therefore the repulsive force disappears. At this moment, the compressed second resilient element 923 will be released and simultaneously generate an elastic force to push the ink cartridge 920 to engage with the body 910 and then allow the first electronic pads 921 in contact with the second electronic pads 935.

FIGS. 10A-10C are schematic cross-section views illustrating the process of disengaging the ink cartridge 920 of the printing apparatus 900 from the body 910 in accordance with a third embodiment of the present invention. The arrow shown in FIG. 10A represents the disengagement direction of the ink cartridge 920. It should be appreciated to a person skilled in the art that the disengagement process is similar to the installation process, and therefore the description thereof is omitted. Note that there is an ink residue 1001 on a first plane 922. When the ink cartridge 920 is pulled upwards, a repulsive force is generated as the first magnetic element 950 approaches to the second magnetic element 960. The repulsive force can isolate the first electronic pads 921 from the second electronic pads 935 and also isolate the second electronic pads 935 from the ink residue 1001.

FIGS. 11A-11C are schematic cross-section views illustrating a printing apparatus 1100 of a fourth embodiment of the present invention. The difference between the fourth embodiment and the third embodiment is the position of the magnetic element, which will be described below. The arrow shown in FIG. 11A represents the installation direction of the ink cartridge 1120. A first magnetic element 1150 of a printing apparatus 1100 is disposed in an ink cartridge 1120, and a second magnetic element 1160 is disposed in a body 1110. The first magnetic element 1150 includes a first surface 1151 configured to be opposite to a second surface 1161 of the second magnetic element 1160. In this embodiment, a plurality of first electronic pads 1121 cover the first surface 1151 while a plurality of second electronic pads 1135 don't cover the second surface 1161. During the installation of the ink cartridge 1120, the first magnetic element 1150 will sequentially pass the second magnetic element 1160 and the second electronic pads 1135. As shown in FIG. 11B, a repulsive force is generated as the first magnetic element 1150 approaches the second magnetic element 1160. The repulsive force can isolate the first electronic pads 1121 from the second electronic pads 1135 and simultaneously compress the second resilient element 1123. Next, as shown in FIG. 11C, the ink cartridge 1120 continues to be pushed into a space 1112, so that the first magnetic element 1150 does not confront the second magnetic element 1160 and therefore the repulsive force disappears. At this moment, the compressed resilient element 1123 will be released to generate an elastic force and then push the ink cartridge 1120 to engage with the body 1110 as well as allowing the first electronic pads 1121 in contact with the second electronic pads 1135.

Note that in the fourth embodiment, the disengagement process of the ink cartridge 1120 and the isolation of the ink residue are similar to the other embodiments as aforementioned, and therefore the description thereof is omitted.

While this invention has been described with reference to the illustrative embodiments, these descriptions should not be construed in a limiting sense. Various modifications of the illustrative embodiment, as well as other embodiments of the invention, will be apparent upon reference to these descriptions. It is therefore contemplated that the appended claims will cover any such modifications or embodiments as falling within the true scope of the invention and its legal equivalents.

1. A printing apparatus, comprising:
an ink cartridge having a first electronic pad;
a body having a circuit element, the circuit element having a second electronic pad; and
a blocking element selectively disposed on the body and the ink cartridge;
wherein when the ink cartridge approaches the body for installation, the blocking element isolates the first electronic pad from the second electronic pad; and
wherein when the blocking element or the ink cartridge engages with the body, the first electronic pad contacts with the second electronic pad.

2. The printing apparatus of claim 1, wherein the first electronic pad is disposed on a first plane of the ink cartridge, the second electronic pad is disposed on a second plane of the body, and the blocking element is selectively disposed on the first plane and the second plane.

3. The printing apparatus of claim 2, wherein the body further comprises a space for receiving the ink cartridge, and the ink cartridge moves into or away from the space in a direction parallel with the second plane.

4. The printing apparatus of claim 2, wherein the first plane or the second plane further comprises an ink residue, and the blocking element is configured to isolate the first electronic pad or the second electronic pad from the ink residue.

5. The printing apparatus of claim 2, wherein the body further comprises a space for receiving the ink cartridge, and when the blocking element is disposed on the first plane, the blocking element moves into the space before the first electronic pad does during the installation.

6. The printing apparatus of claim 2, wherein when the blocking element is disposed on the first plane, the blocking element is pressed against the second plane and then slides to engage with the body for the installation.

7. The printing apparatus of claim 2, wherein when the blocking element is disposed on the second plane, the blocking element is pressed against the first plane and then slides to engage with the ink cartridge for the installation.

8. The printing apparatus of claim 1, wherein the ink cartridge further comprises a plurality of first electronic pads, and the circuit element further comprises a plurality of second electronic pads respectively corresponding to each first electronic pads.

9. The printing apparatus of claim 8, wherein the circuit element further comprises:
a circuit board having the plurality of the second electronic pads; and
a first resilient element connecting to the circuit board, the first resilient element having a plurality of protrusions, respectively corresponding to each second electronic pads, for facilitating the contacts of the first electronic pads and the second electronic pads.

10. The printing apparatus of claim 1, wherein the body further comprises a second resilient element connecting to the circuit element,
wherein when the ink cartridge approaches the body for the installation, the second resilient element is compressed; and
wherein when the blocking element engages with the ink cartridge or the body, the second resilient element generates an elastic force to make the circuit element tightly contact the ink cartridge.

11. The printing apparatus of claim 1, further comprising a gap, selectively disposed on the body and the ink cartridge, for receiving the blocking element.

12. A printing apparatus, comprising:
an ink cartridge having a first electronic pad;
a first magnetic element disposed on the ink cartridge;
a body having a circuit element, the circuit element having a second electronic pad; and
a second magnetic element disposed on the body;
wherein when the ink cartridge approaches the body for installation, a repulsive force generated from the first magnetic element and the second magnetic element isolates the first electronic pad from the second electronic pad; and
wherein when the repulsive force is absent, the first electronic pad contacts the second electronic pad.

13. The printing apparatus of claim 12, wherein when the ink cartridge moves away from the body for disengagement, the repulsive force isolates the first electronic pad from the second electronic pad.

14. The printing apparatus of claim 12, wherein the body further comprises a space for receiving the ink cartridge, and the blocking element moves into the space before the first electronic pad does during the installation.

15. The printing apparatus of claim 12, wherein the first electronic pad is disposed on a first plane of the ink cartridge, the second electronic pad is disposed on a second plane of the body, and the first plane is opposite to the second plane.

16. The printing apparatus of claim 15, wherein the body further comprises a space for receiving the ink cartridge, and the ink cartridge moves into and away from the space in a direction parallel with the second plane.

17. The printing apparatus of claim 15, wherein the first plane or the second plane further comprises an ink residue, and the first magnetic element and the second magnetic are configured to isolate the first electronic pad or the second electronic pad from the ink residue.

18. The printing apparatus of claim 12, wherein the ink cartridge further comprises a plurality of first electronic pads, and the circuit element further comprises a plurality of second electronic pads respectively corresponding to each first electronic pads.

19. The printing apparatus of claim 18, wherein the circuit element further comprises:
a circuit board having the plurality of the second electronic pads; and
a first resilient element connecting to the circuit board, the first resilient element having a plurality of protrusions, respectively corresponding to each second electronic pad, for facilitating the contacts of the first electronic pads and the second electronic pads.

20. The printing apparatus of claim 12, wherein the body further comprises a second resilient element connecting to the circuit element;
wherein when the repulsive force is present, the second resilient element is compressed; and
wherein when the repulsive force is absent, the second resilient element generates an elastic force to make the circuit element tightly contact the ink cartridge.
